(19) United States
(12) Patent Application Publication
(10) Pub. No.: US 2006/0190480 A1
(43) Pub. Date: Aug. 24, 2006

(54) Generation of names related to organization actions

(75) Inventors: Barak Ori, Palo Alto, CA (US); Noam Rotem, Palo Alto, CA (US); Eyal Rubin, Palo Alto, CA (US)

Correspondence Address: CARR & FERRELL LLP, 2200 GENG ROAD, PALO ALTO, CA, 94303, US

(73) Assignee: Transparency Software, Inc.

(21) Appl. No.: 11/319,822

(22) Filed: Dec. 27, 2005

Related U.S. Application Data
(63) Continuation-in-part of application No. 11/285,908, filed on Nov. 23, 2005.
(60) Provisional application No. 60/655,347, filed on Feb. 22, 2005.
(60) Provisional application No. 60/655,611, filed on Feb. 22, 2005.
(60) Provisional application No. 60/707,838, filed on Aug. 11, 2005.

(51) Int. Cl. G06F 17/00

(52) U.S. Cl. 707/103 R

(57) ABSTRACT

A system for generating names related to organization actions performed with applications includes a communications interface and a processor. The communications interface receives data sent between an application and a server in response to a user interacting with the application. The processor processes the data to determine an organization action performed with the application. The processor generates a name related to the organization action based on the data.

### CROSS-REFERENCE TO RELATED APPLICATION

This application is a continuation-in-part of U.S. application Ser. No. 11/285,908, filed Nov. 23, 2005 and entitled “System and Method for Determining Information Related to User Interactions with an Application,” which claims the benefit of U.S. Provisional Application No. 60/655,347, filed Feb. 22, 2005 and entitled “System for Enhanced Database Analysis,” U.S. Provisional Application No. 60/655,611, filed Feb. 22, 2005 and entitled “Method for Enhanced Database Analysis,” and U.S. Provisional Application No. 60/707,838, filed Aug. 11, 2005 and entitled “Database Analysis.”

### BACKGROUND

1. Technical Field

The present invention relates generally to monitoring performance of applications and servers and more particularly to generating names related to organization actions performed with the applications.

2. Description of Related Art

Online Transaction Processing (OLTP) is a form of transaction processing conducted via communication networks, such as the Internet. Some examples of OLTP include electronic banking, order processing, employee time clock systems, e-commerce, and eTrading. Users interact with OLTP applications to perform one or more activities (such as booking a flight or reserving a rental car) that serve well-defined purposes or goals in an organization. To fulfill the purposes or goals, the activities performed by the users also typically need to access and/or manipulate the organization's data in storage servers. Users interacting with the OLTP applications can access the storage servers to manipulate the organization's data and define the data structure.

An administrator user in the organization typically monitors performance of the storage servers and maintains the integrity, availability, and recoverability of the organization's data. The administrator user also ensures efficient and successful processing of transactions between the OLTP applications and the storage servers. To aid the administrator user in performing his or her duties, numerous storage server analysis tools have been developed. One example of a storage server analysis tool is the Oracle Enterprise Manager for Oracle Databases by Oracle Corporation of Redwood Shores, Calif. The Oracle Enterprise Manager displays to the administrator user (e.g., a database administrator) server instances, sessions, user privileges, and storage of an Oracle database server.

One problem with the storage server analysis tools, such as the Oracle Enterprise Manager, is that the tools provide overwhelming amounts information sent between the OLTP applications and the storage servers. For example, in addition to server instances, sessions, user privileges, and storage of an Oracle database server, the Oracle Enterprise Manager displays copious amounts of raw data in the form of queries (e.g., Structure Query Language statements) sent to the Oracle database server. As the number of users interacting with OLTP applications increases, reports generated by the Oracle Enterprise Manager may contain hundreds or thousands of queries.

Another problem is that the tools provide minimal information to the administrator user about the activities performed in the OLTP applications by users that serve purposes or goals in the organization. The tools typically only provide information about the storage servers, but not about the activities performed in the OLTP applications, because the user does not interact directly with the storage servers. The administrator user cannot quickly extract or decipher which portions of the raw data represent or are related to the activities performed by the users in the OLTP applications. The administrator user cannot quickly identify problems from the raw data to troubleshoot performance issues between the OLTP applications and the storage servers. Additionally, the administrator user cannot quickly correlate problems reported by users to the raw data to diagnose issues between the OLTP applications and the storage servers.

### SUMMARY OF THE INVENTION

The invention addresses the above limitations by providing a system for generating names related to organization actions performed with applications. The system includes a communications interface and a processor. The communications interface receives data sent between an application and a server in response to a user interacting with the application. The processor processes the data to determine an organization action performed with the application. The processor then generates a name related to the organization action based on the data. The processor may store the name in a storage device. The processor may also generate a report based on the name for display to an administrator user.

In some embodiments, the communications interface receives the data as packets. The processor may generate the name related to the organization action based on at least one operation reference in the data. The processor may also generate the name related to the organization action based on at least one object reference in the data. In further embodiments, the processor generates the name related to the organization action based on a predetermined name retrieved from a set of predetermined names. The processor may also generate the name related to the organization action based on input received from an administrator user. The processor may map the name to the organization action performed with the application.

The system advantageously provides explanatory and illustrative names related to organizations actions (for example, for technical transactions, organization actions, and organization scenarios). Based on object references in the data, such as table identifiers for tables located in a database, the system may generate a name for an organization action that includes references to the tables in the database accessed and/or manipulated when a user performs the organization action with the application. Furthermore, the system may generate names from operation references in the data that indicate functions or tasks performed in the application and/or the server. By searching reports based on the names, the administrator user can readily correlate the names generated by the system to problems reported by users and more easily monitor application and server performance.

### BRIEF DESCRIPTION OF THE DRAWINGS

FIG. 1 is a block diagram of a system for determining a description of interactions of users with an application, in an exemplary implementation of the invention;

FIG. 2 is an illustration of a technical transaction with Structured Query Language (SQL) queries, in an exemplary implementation of the invention;

FIG. 3 is a flowchart for determining the technical transaction of FIG. 2 based on the interaction of the user with the application, in an exemplary implementation of the invention;

FIG. 4 is a flowchart for determining a business action based on the interaction of the user with the application, in an exemplary implementation of the invention;

FIG. 5 is a report illustrating descriptions of interactions of users with applications, in an exemplary implementation of the invention;

FIG. 6 is a list of statements sent from an application to a server, in an exemplary implementation of the invention;

FIG. 7 is a list of descriptions of interactions of users with the application based on the statements in the list of FIG. 6, in an exemplary implementation of the invention;

FIG. 8 is a table illustrating a “Patient Login” description from the table of FIG. 7, in an exemplary implementation of the invention;

FIG. 9 is a report for an administrator user with descriptions of interactions of users with applications, in an exemplary implementation of the invention;

FIG. 10 is a flowchart for generating a name for a technical transaction, in an exemplary implementation of the invention;

FIGS. 11A and 11B are a flowchart for generating a name for a organization action based on SQL statements, in an exemplary implementation of the invention;

FIG. 12 is a flowchart for generating a name for an organization scenario from a predetermining name stored in a database, in an exemplary implementation of the invention; and

FIG. 13 is a block diagram of a collector and an analyzer, in an exemplary implementation of the invention.

### DETAILED DESCRIPTION OF THE INVENTION

The embodiments discussed herein are illustrative of one example of the present invention. In order to better understand the present invention, aspects of the environment within which the invention operates will first be described. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

Determining Information Related to User Interactions with an Application

In general, a system for determining information related to user interactions with an application provides a bridge to monitor performance in a system where the application sends data to a server in response to the user interacting with the application. The system includes a collector, an analyzer, and a storage device. The collector inspects data sent from the application to the server in response to the user interacting with the application. The analyzer determines, based on the data, a description of the interaction of the user with the application and the server. The system then stores the description of the interaction of the user in the storage device.

In one example, in response to a user interacting with an application, the application sends one or more queries to a database server to create, modify, retrieve, and/or delete data in the database server. The system determines from the one or more queries a description of the interaction of the user with the application. The description may include one or more technical transactions and form part of a business scenario.

The system allows the administrator user to quickly identify user interactions based on the description that cause poor performance, errors between the application and the server, and unavailability of server resources. The system also may use the description of the interaction of the user with the application to recognize subsequent identical and/or similar user interactions performed by the same or other users to monitor and adjust performance between the application and the server. Additionally, the system may generate a report of the description of the interaction of the user with the application for compliance and regulatory purposes.

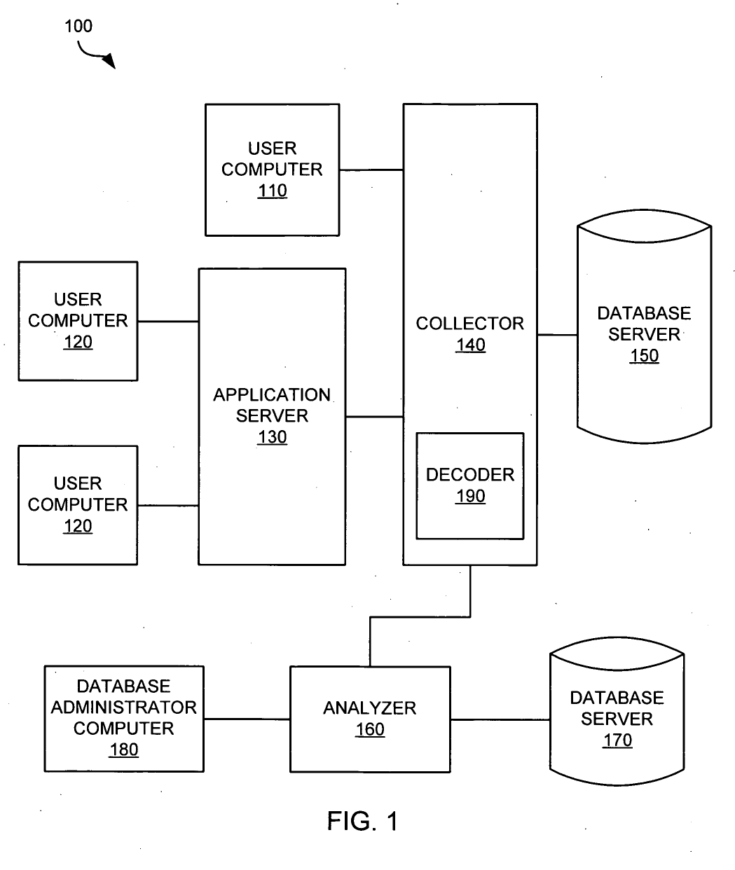

FIG. 1 is a block diagram of a system 100 for determining a description of interactions of users with an application, in an exemplary implementation of the invention. The system 100 includes a user computer 110, user computers 120, an application server 130, a collector 140, a database server 150, an analyzer 160, a database server 170, and a database administrator computer 180. The collector 140 includes a decoder 190.

The user computer 110 is linked to the collector 140. The user computers 120 are linked to the application server 130. One user computer 110 and two user computers 120 are shown for the sake of simplicity, although multiple user computers 110 and multiple user computers 120 may be included. The application server 130 is linked to the collector 140. The collector 140 is linked to the database server 150 and the analyzer 160. The analyzer 160 is linked to the database server 170 and the database administrator computer 180.

Some examples of the user computers 110 and 120 and the database administrator computer 180 are general purpose computers. In one example, the user computer 110 comprises a personal computer (PC) that executes a software application for communicating with the database server 150 (e.g., by sending SQL queries to the database server 150 via the collector 140). In another example, the user computers 120 comprise PCs that execute applications for communicating with the database server 150 through the application server 130. In yet another example, the user computers 110 and 120 may comprise a first database server sending SQLs to a second database server (e.g., the application server 130) via a database link mechanism. Alternatively, the user computers 110 and 120 and the database administrator computer 180 may comprise any workstations, mainframes, networked clients, and/or application servers. An administrator user, such as a database administrator for the database server 150, uses the database administrator computer 180 to monitor performance of the system 100. The administrator user may be a natural person or a computer program, job, or process.

The application server 130 comprises hardware and/or software elements that execute software applications. The application server 130 may accept input from another computer (e.g., the user computers 120). In this example, the application server 130 comprises a BEA Weblogic Server running a Medical Records Application. The Medical Records Application is configured to transmit SQL queries to a database server (e.g., the database server 150) on behalf of the user computers 120. Alternatively, the application server 130 may comprise an application executed on the server (e.g., the database server 150). The database server 150 comprises hardware and/or software elements that stores data and provides access to the data. The database server 150 may store a collection of data in a systematic way such that a user interacting with a computer application (e.g., the application server 130) can consult the database server 150 to manipulate the data and define the data structure. One example of the database server 150 is an Oracle 9i Database application executed on a server running the Red Hat 2.1 Advanced Server operating system.

The collector 140 comprises hardware and/or software elements that inspect data sent from an application (e.g., the application server 130) to a server (e.g., the database server 150). Some examples of the data are server protocols (e.g., Transmission Control Protocol/Internet Protocol (TCP/IP) packets, Hypertext Transfer Protocol (HTTP) messages), Lightweight Directory Access Protocol (LDAP) requests and responses, Simple Object Access Protocol (SOAP) data, Internet Inter-ORB Protocol (IIOP) data, Structured Query Language (SQL) statements, and inter-process communications. An application is any program designed for end users that performs tasks and/or functions for the end-user, whether a natural person or another computer program, process, job, or service. Applications typically interact, call, or sit on top of system software and operating systems. Some examples of applications are word processors, web browsers, and database clients.

A server is any hardware and/or software elements that manage network resources and provides access to the network resources. For example, a file server is a computer and storage device dedicated to storing files where a user on the network can store files on the file server. A server can also refer to the computer software program that is managing resources rather than the entire computer. Some examples of the server are database servers (e.g., Oracle, UDB/DB2, MYSQL, IMS, Sybase, MSSQL, as well as any other flat-file database, hierarchical database, and relational database), directory servers (e.g., Lightweight Directory Access Protocol (LDAP) servers), file servers, storage servers, message servers, and other applications servers.

The collector 140 of this exemplary embodiment, for example, comprises a hardware database proxy server. The collector 140 receives data (e.g., queries) on behalf of the database server 150 and forwards the queries to the database server 150. Alternatively, the collector 140 may comprise a software proxy. For example, in one embodiment, the collector 140 comprises a software proxy running on the database server 150. In some embodiments, the collector 140 comprises a “sniffer” that sniffs the data from a communication network coupling the application server 130 and the database server 150. The collector 140 may be configured to sniff any client/server configuration. Alternatively, the collector 140 may inspect the data by inspecting memory activity of the server, inspecting inter-process communications, inspecting server processes, inspecting server logs, inspecting driver instrumentation activity for the server, inspecting protocol packets accessing the server, and inspecting other network levels.

Advantageously, the collector 140 may be embodied in hardware, software, and/or firmware to provide flexibility for integrating the collector 140 into existing hardware and software deployments. Additionally, the sniffing feature of the collector 140 provides transparency to the user computer 110 and the application server 130 during access to the database server 150. In some embodiments, the collector 140 includes the decoder 190. The decoder 190 comprises hardware and/or software elements that decode the data inspected by the collector 140. For example, the decoder 190 may decode the data comprising Oracle 9i Oracle Database Transparent Network Substrate (TNS) and Two-Task Common (TTC) data streams. The decoder 190 then may transmit the decoded data to the analyzer 160. In still other embodiments, the decoder 190 may be located outside of the collector 140. The decoder 190 may also be included in the analyzer 160.

The analyzer 160 comprises hardware and/or software elements that determine a “description” of an “interaction” of a “user” with an application and a server. A “description” comprises any combination of information, such as an outline, depiction, categorization, or characterization, about the interaction of the user with the application. The analyzer 160 determines the description directly or indirectly based on data sent from the application to the server in response to the interaction of the user with the application.

In the following example, the analyzer 160 determines a description of a “User Login” for a user entering a username and a password in an application. The user clicks a “Submit” button and the application sends data containing the username and the password to a server to authenticate the user. The “User Login” description includes, for example, information based on the data such as the username and the password. The “User Login” description may also include the name of the application, application-server connection information, and the date and time the application sent the data. The description may include other information derived directly or indirectly from the username. The analyzer 160 may use the “User Login” description as a template to recognize other user interactions with the application that causes the application to send a username and a password to the server.

A “user” may be a natural person and/or another computer application interacting with the application. For example, the user may be any service, job, process, and/or thread interacting with the application. In another example, the user may be a first database server sending SQLs to the application (e.g., a second database server) via a database link mechanism. An “interaction” of a user with an application comprises any activity, contact, interface, or task by the user with the application that directs the application to send data to the server. Some examples of interactions of users with applications are clicking a button, generating a report, logging on to the applications, and entering data into the applications.

In some embodiments, the analyzer 160 determines a “technical transaction” based on the description. A “technical transaction” is a sequence of one or more server protocol statements (e.g., SQL queries) and an end sequence indicator. An end sequence indicator comprises, for example, a “COMMIT” or “ROLLBACK” statement, cursor activity, a predefined delimiter, or a continuous number of seconds of idle connection time at the server. A technical transaction may include a sequence of commands that insert, delete, update, or retrieve data from an enterprise storage system (e.g., the database server 150). In another example, a technical transaction is an atomic operation where either a server approves the one or more server protocol statements and therefore performs the one or more protocol statements (Commit) or the server rejects the one or more server protocol statements (i.e. none of one or more server protocol statements are performed (Roll back)).

In some embodiments, the analyzer 160 determines a “business action” performed by the user based on the description. A “business action” (also known as an organization action) is any “user click,” “service,” or “job.” A “user click” is any action (e.g., a mouse click or key press) of a user with a user interface device (e.g., a mouse or keyboard) on an interactive element (e.g., a button) in an application that causes the application to access a server. A user click business action may begin after the user click on the first interaction with the server and end on the last interaction with the server. A “service” is any request by a first application to a second application to provide a function (e.g., Fraud Detection or Weather check). A service business action may begin after the service request and on the first interaction with the server and end on the last interaction with the server. A “job” is any function, routine, or procedure that is activated in a recurring fashion (e.g., by a job scheduler). A job business action may comprise interaction performed by the job from the job start to finish.

Some examples of business actions are a user click on a “Submit” button that approves a purchase made on an Ecommerce site, a user click on a “Submit” button choosing a hotel to be reserved in a vacation reservation application, a service requested by another application to check fraud detection, and a report job executed on an hourly basis that issues a summary of new customers added to a system in the last hour. The analyzer 160 may determine business actions based on cursor activity (e.g., a single key/data pair in the database), connection activity to a server (e.g., the database server 150), schema activities, and time indicators for the user, application, and/or the server, and one or more technical transactions.

In some embodiments, the analyzer 160 determines a “business scenario” between the user, the application, and the server based on the description. A business scenario comprises a sequence of user-application interactions. One example of a business scenario includes one or more business actions and a time indicator. The time indicator comprises, for example, the execution and/or idle time of the one or more business actions, the time the user takes between user interactions with the application, and/or the time that the server is idle (e.g., idle time for the database server 150). Another example of a business scenario is a “Vacation Reservation” which includes a sequence of business actions (e.g., “Reserve Flight->Confirm Flight Reservation->Reserve Hotel->Confirm Hotel Reservation->Reserve Car->Confirm Car Reservation->Proceed to checkout->Payment Mechanism->Approve Purchase Order”).

In one example of operation, the user computer 110 and the application server 130 send data to the database server 150 via the collector 140 to enable interactions of users (e.g., technical transactions, business actions, and/or business scenarios) with the user computers 110 and 120, the application server 130, and the database server 150. The collector 140 acts as a proxy to the database 150 and inspects the data sent to the database server 150.

The decoder 190 in the collector 140 converts the data (e.g., to SQL queries) to a format understandable by the analyzer 160. The collector 140 then forwards the SQL queries to the analyzer 160. The analyzer 160 determines descriptions of the interactions of the users with the application (e.g., the application server 130) based on the SQL queries. The analyzer 160 stores the descriptions, including the SQL queries, in the database server 170.

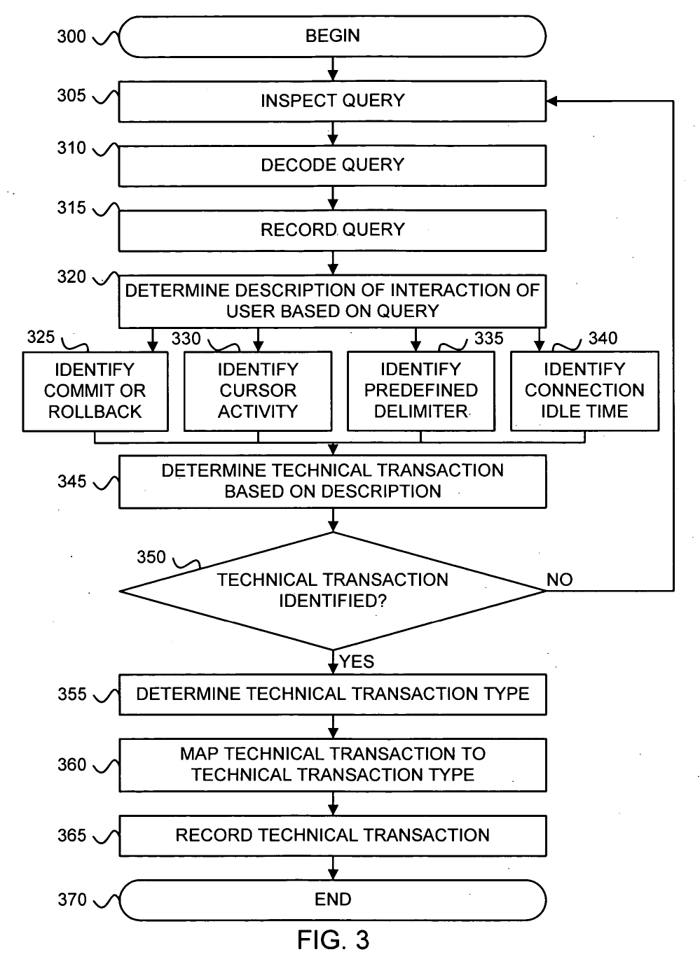

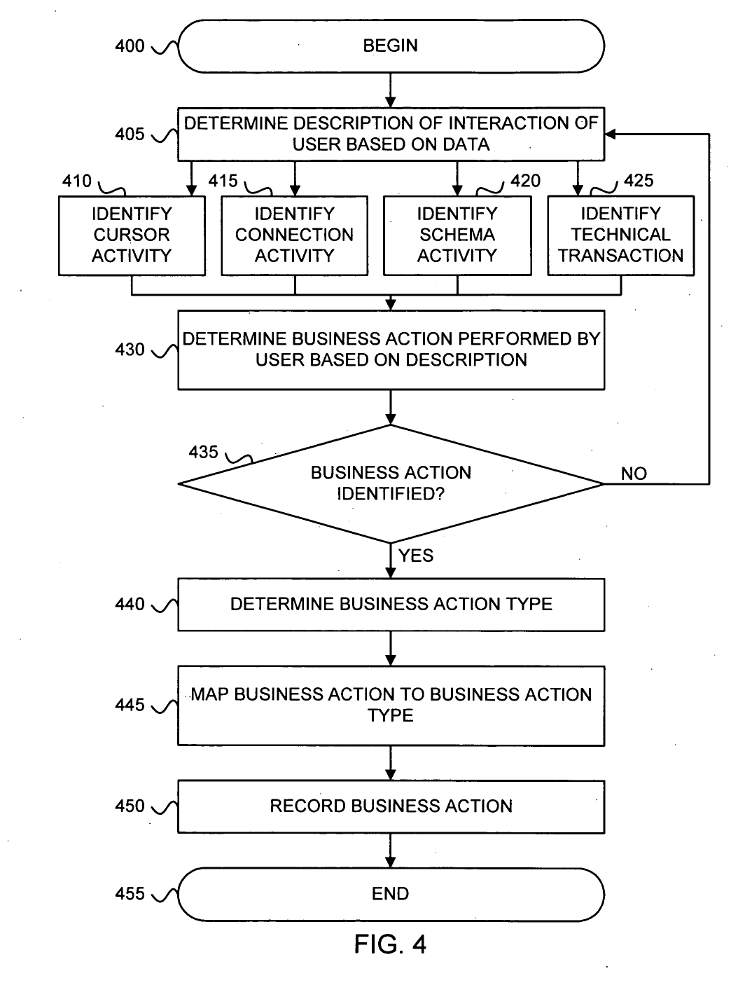

The operations of the collector 140 and the analyzer 160 are described further in FIGS. 3 and 4. Advantageously, the system 100 provides an administrator user a report or log of the descriptions of interactions of users on the database administrator computer 180. The administrator user can quickly identify interactions of users based on the descriptions that cause poor performance, unavailable resources, or errors in the database server 150.

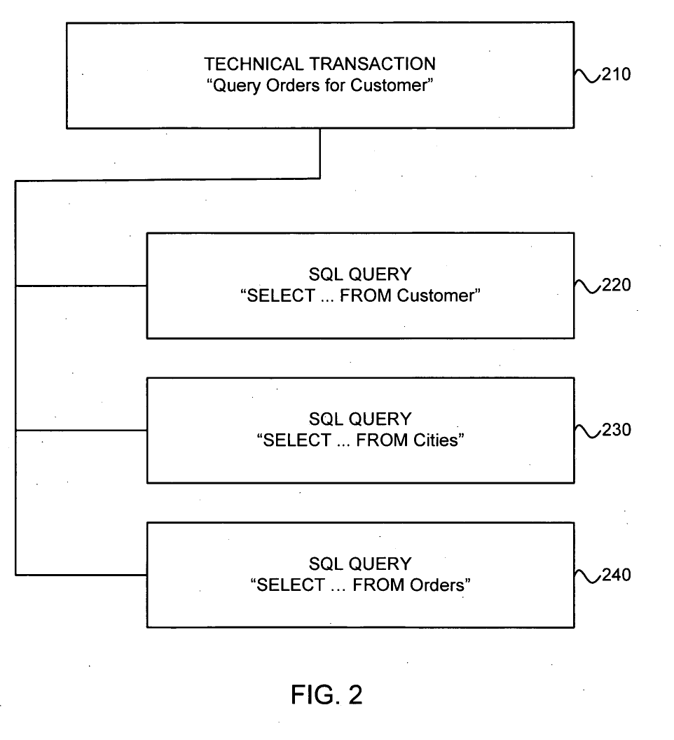

FIG. 2 is an illustration of a technical transaction 210 with Structured Query Language (SQL) queries, in an exemplary implementation of the invention. The technical transaction 210 includes a SQL query 220, a SQL query 230, and a SQL query 240. The technical transaction 210 may also include the sequence in which the SQL queries 220, 230, and 240 are received by the database server 150.

In this example, the application server 130 sends the SQL queries 220, 230, and 240 to the database server 150 in response to the interaction of a user (e.g., one of the user computers 120) with the application server 130. The technical transaction 210 represents the interaction of the user with the application server 130 to request customer order information from the database server 150. Here, the SQL query 220 selects customer information (e.g., the customer name) from the “Customer” table in the database server 150. The SQL query 230 selects customer city information from the “Cities” table in the database server 150. The SQL query 240 selects customer order information from the “Orders” table in the database server 150. The database server 150 processes each of the queries 220, 230, and 240 and returns the results of each query, if any, to the application server 130 for the user.

When the queries 220, 230, and 240 are sent to the database server 150, the analyzer 160 inspects the queries 220, 230, and 240. As discussed with respect to FIG. 1, the analyzer 160 determines a description of the interaction of the user (e.g., the “Query Orders for Customer” technical transaction 210) based on the queries 220, 230, and 240. In one embodiment, the analyzer 160 further determines a regular expression from the queries 220, 230, and 240 that represents the technical transaction 210. The regular expression describes or matches a set, according to certain syntax rules. Here, the regular expression describes and matches the set of strings formed by the queries 220, 230, and 240 sent to the database server 150. The sequence comprised by the query 220, followed by the query 230, and then followed by the query 240 defines the syntax rules of the regular expression. The analyzer 160 may use the regular expression to match subsequent queries to determine whether a user is attempting to subsequently perform the same technical transaction (e.g., the technical transaction 210). Therefore, when the analyzer 160 sees the sequence of the queries 220, 230, and 240 in the order matched by the regular expression, the analyzer 160 may determine that the technical transaction 210 has reoccurred.

Additionally, the analyzer 160 may determine a finite state machine representing the transaction 210 to determine further information and state related to the technical transaction 210. The database administrator may view a report generated by the system 100 to view the description of the user interaction associated with the technical transaction 210, such as when the user performed the technical transaction 210, how many times the technical transaction 210 was performed, and the user (e.g., the username) that performed the technical transaction 210.

FIG. 3 is a flowchart for determining the technical transaction 210 of FIG. 2 based on the interaction of the user with the application, in an exemplary implementation of the invention. FIG. 3 begins in step 300. In step 305, the collector 140 inspects data (e.g., the SQL queries 220, 230, and 240) sent from the application server 130 to the database server 150. In step 310, the decoder 190 decodes the SQL queries 220, 230, and 240. In step 315, the analyzer 160 records the SQL queries 220, 230, and 240 in the database server 170.

In step 320, the analyzer 160 analyzes the SQL queries 220, 230, and 240 to determine a description of the interaction of the user based on the SQL queries 220, 230, and 240. In steps 325-340, the analyzer 160 may identify the end sequence indicator for the technical transaction 210. In step 325, the analyzer 160 identifies “COMMIT” and/or “ROLLBACK” statements between the application server 130 and the database server 150. Alternatively, in step 330 the analyzer 160 identifies cursor activity between the application server 130 and the database server 150. In another alternative, in step 335, the analyzer 160 identifies a predefined delimiter. In yet another alternative, the analyzer 160 identifies connection idle time between the application server 130 and the database server 150.

In step 345, the analyzer 160 determines a technical transaction (e.g., the technical transaction 210) based on the description. In some embodiments, the analyzer 160 determines the technical transaction 210 based on a probability. The analyzer 160 may determine and/or recognize the technical transaction 210 based on a partial description, such as 90% complete, 80% complete, or 50% complete. In step 350, if the technical transaction 210 is not identified or is unrecognized, the collector 140 continues to inspect data sent from the application server 130 to the database server 150 in step 305.

If the technical transaction 210 is identified, the analyzer 160 determines the type of the technical transaction 210 in step 355. Some examples of types are selection of a greater number of columns from a table, selection of a greater number tables, inclusion of a Data Manipulation Language (DML) command, inclusion of a Data Definition Language (DDL) command, inclusion of a group by query, and affecting more rows in the table. If more than one technical transaction includes the identical server protocol statements, secondary types may be used, such as the order of server protocol statements and/or cursor activity. In step 360, the analyzer 160 maps the technical transaction 210 to the type of transaction. In step 365, the analyzer 160 records the technical transaction 210 in the database server 170. FIG. 3 ends in step 370.

FIG. 4 is a flowchart for determining a business action based on the interaction of the user with the application, in an exemplary implementation of the invention. FIG. 4 begins in step 400. In step 405, the analyzer 160 determines a description of the interaction of the user based on data sent between the application server 130 and the database server 150. In step 410, the analyzer 160 identifies cursor activity between the application server 130 and the database server 150. Alternatively or in combination, in step 415 the analyzer 160 identifies connection activity between the application server 130 and the database server 150. In another alternative or combination, in step 420, the analyzer 160 identifies schema activity. In yet another alternative or combination, in step 425, the analyzer 160 identifies a technical transaction (e.g., the technical transaction 210). In step 430, the analyzer 160 determines a business action based on the description (e.g., including the cursor activity, the connection activity, the schema activity, and/or the technical transaction 210).

In step 435, if the analyzer 160 does not determine a business action, the analyzer 160 continues to receive data from the collector 140 in step 405. In step 435, if the analyzer 160 determines a business action (e.g., recognizes or identifies the business action), the analyzer 160 determines a type for the business action in step 440. In one example, the business action type is selected from the types of technical transactions previously described. In other examples, the business action type comprises the type of the cursor activity, connection activity, schema activity, or technical transaction forming or taking part in the business action. In some embodiments, the analyzer 160 determines the business action based on a probability. The analyzer 160 may determine and/or recognize the business action based on a partial description, such as 90% complete, 80% complete, or 50% complete. In step 445, the analyzer 160 maps the business action to the business action type. In step 450, the analyzer 160 records the business action in the database server 170. FIG. 4 ends in step 455.

Advantageously, the system 100 may generate a report containing the descriptions (e.g., technical transactions and business actions) of interactions of users with the application server 130 and the database server 150. The database administrator may adjust performance of the application server 130 and/or the database server 150 to prioritize one or more technical transactions and/or business actions based on the descriptions of the technical transactions and/or business actions. The database administrator can determine from the report that some user interactions with the application server 130 (i.e., execution of particular technical transactions and/or business actions) will deteriorate server performance and/or otherwise affect interactions of other users with the application server 130 and the database server 150. Additionally, if types of technical transactions and/or business actions should only be executed by particular users, the database administrator may quickly determine from the report whether executions or abuses have occurred by non-authorized users.

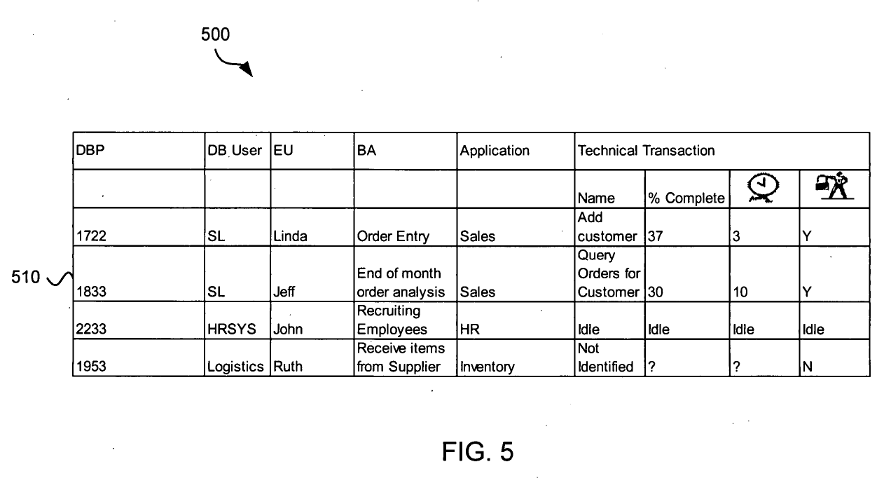

FIG. 5 is a report 500 illustrating descriptions of interactions of users with applications, in an exemplary implementation of the invention. The report 500 particularly shows information about the descriptions of four business actions and the technical transactions of four users. For example, row 510 illustrates a database process (DBP) “1833” of a database user (DB User) “SL” and an end user (EU) “Jeff.” In this example, the end user “Jeff” is using the “Sales” (Application) to perform end of month customer order analysis (Business Action or BA). As part of the end of month customer order analysis, the end user “Jeff” performs the “Query Orders for Customer” (Technical Transaction/Name), for example, the technical transaction 210.

In the last three columns of row 510, the database administrator can determine that the “Query Orders for Customer” technical transaction 210 is 30% complete. The technical transaction 210 is also shown to have 10 minutes remaining until completion in the second to last column of the row 510. No errors in the technical transaction 210 are reported in the last column of the row 510 (by the Y indicating a valid technical transaction). The report 500 may also show the validity of the technical transaction 210 and whether the technical transaction 210 meets regulatory or statutory compliance rules. The report 500 may further show performance metrics, enforcement and violations of policies, and resource consumption.

In embodiments where the analyzer 160 determines the state for recognized technical transactions and/or business actions (e.g., a finite state machine for the technical transaction 210), the analyzer 160 may report errors that occur, if any, during the progress of the technical transaction 210 and the business action that includes the technical transaction 210. The database administrator quickly discovers errors as the database administrator may determine when and at what state during the technical transaction 210 and/or the business action the error occurred. Additionally, the database administrator may recover the data that otherwise might be lost due to the error.

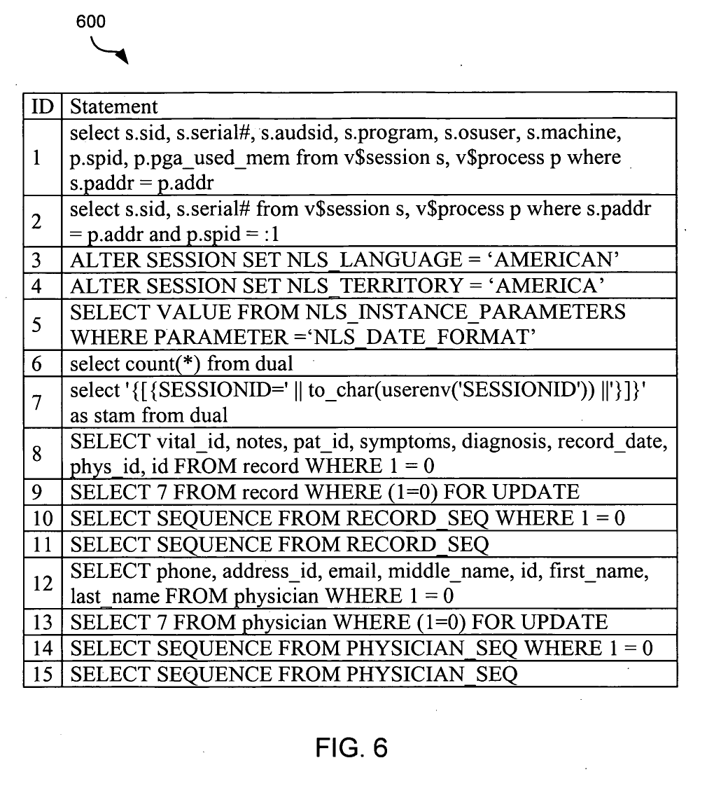

FIG. 6 is a list 600 of statements sent from the application server 130 to the database server 150, in an exemplary implementation of the invention. The “ID” column identifies each statement as a unique element in the list 600. The “Statement” column gives the syntax of each statement. The list 600 may be part of the report generated for the database administrator. The list 600 advantageously allows the database administrator to view all of the statements inspected by the analyzer 160. The list 600 allows the database administrator to determine the sequence of statements to the database server 150 and the operations performed by the statements.

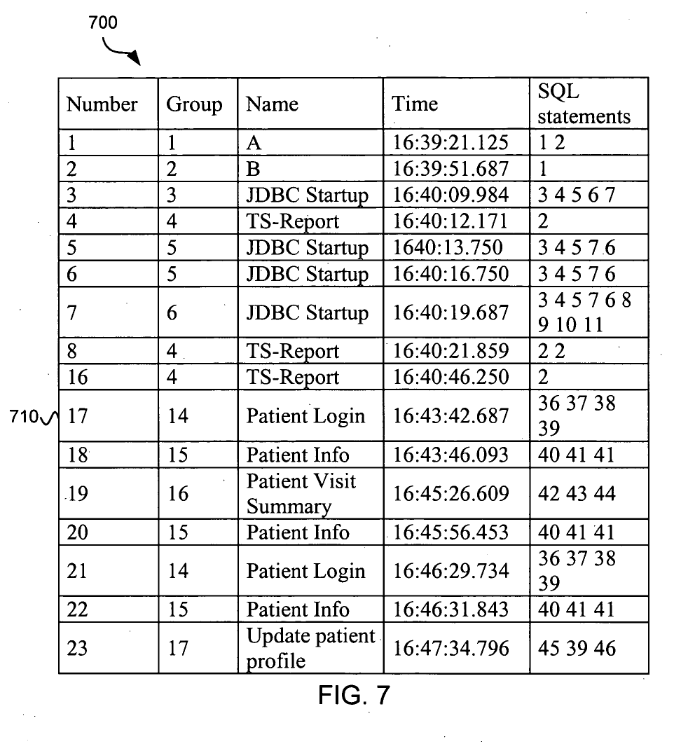

FIG. 7 is a list 700 of descriptions of interactions of users with the application server 130 based on the statements in the list 600 of FIG. 6, in an exemplary implementation of the invention. In this example, the list 700 lists “Number,” “Group,” “Name,” the time of execution, and the SQL statements query IDs associated with each technical transaction and/or business action. For example, technical transaction and/or business action 710 is named “Patient Login.” The Patient Login technical transaction 710 first occurred at 4:43 PM. The SQL queries that comprise the Patient Login technical transaction 710 are identified by SQL query IDs 36, 37, 38, and 39.

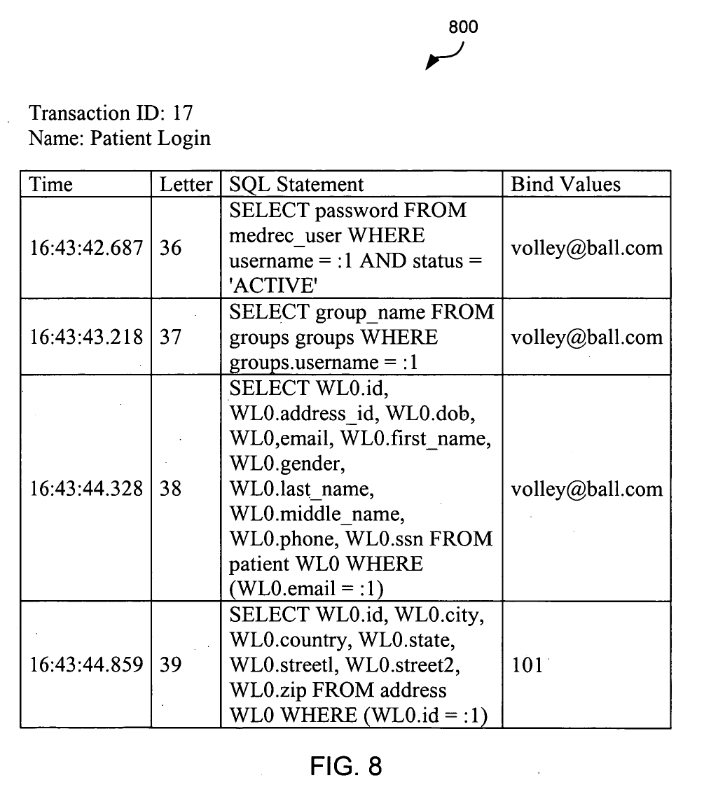

The database administrator may view the list 700 and determine when a technical transaction and/or business action occurred and the SQL queries that represent the technical transaction. For example, the database administrator determines from the report that a user attempt to perform the Patient Login technical transaction 710 has failed. The database administrator further determines from the report when the failed login occurred, the SQL query IDs 36-39, and information related to the Patient Login technical transaction 710 that may have caused the failure. The database administrator may explore further detail about the technical transactions and/or business actions, such as is shown in FIG. 8.

FIG. 8 is a table 800 illustrating a “Patient Login” description from the list 700 of FIG. 7, in an exemplary implementation of the invention. In essence, the table 800 breaks down each transaction (row) of the list 700 into more information related to the technical transaction. Here, the database administrator views the SQL queries 36-39 and associated bind values that describe the “Patient Login” technical transaction 710 of FIG. 7 in more detail (instead of only their respective numbers).

In particular, the database administrator may view the bind values associated with the SQL queries 36-39. For example, here, the database administrator determines that the user associated with the username “volley@ball.com” attempted to perform the Patient Login transaction 710 of FIG. 7. By recording the queries and the information related to the technical transaction, the systems and methods advantageously allow the database administrator to monitor and view technical transactions performed by users of the database server 150. The database administrator may also recover data from the information related to each technical transaction and/or business action.

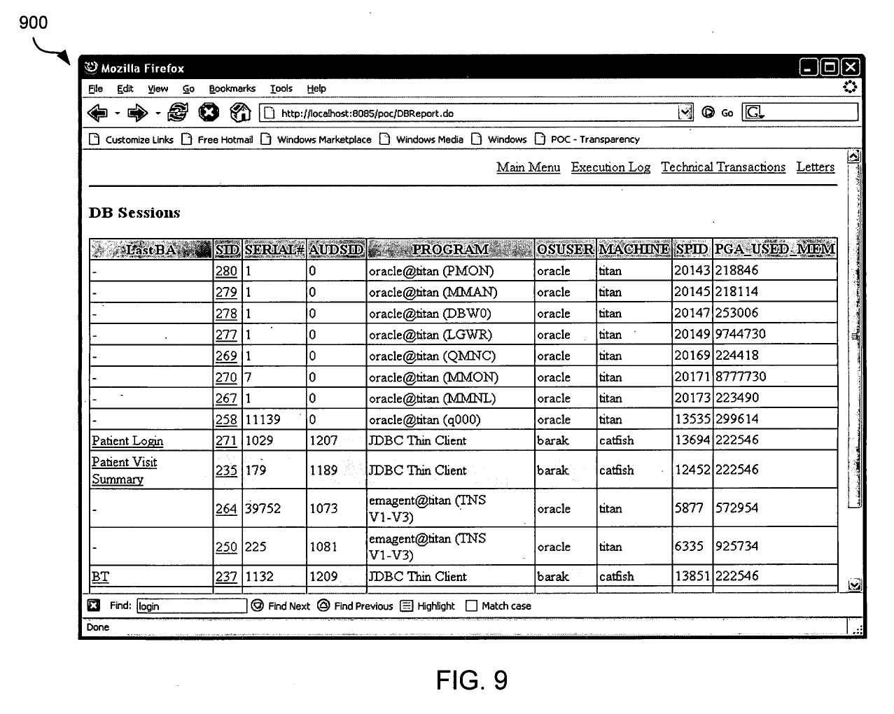

FIG. 9 is a report 900 for an administrator user with descriptions of interactions of users with applications, in an exemplary implementation of the invention. The report 900 provides an overview of information related to technical transactions and business actions of users in the system 100. In this example, the database administrator may view the business actions (Last BA) completed by a user (OSUSER), on what machine (MACHINE) the error occurred or the user is located, and other information (i.e., SID, SERIAL#, AUDSID, PROGRAM, SPID, and PGA) related to the application server 130 and the database server 150.

The database administrator may click on, for example, the Last BA or the SID to view more detailed information about the Last BA or the SID. In this example, the database administrator may click on the “Patient Login” Last BA to view a report such as the table 800 described with respect to FIG. 8. In another example, SID comprises information about a particular user session. Clicking on the SID 271, for example, would list the transactions performed by the OSUSER “barak” connecting from the MACHINE “catfish” such as the list 700 described with respect to FIG. 7.

The database administrator would be able to click on a technical transaction and the queries representing the technical transaction performed by the OSUSER “barak” to view reports that are more detailed. For example, lists 600-700, table 800, and report 900 may be linked such that report 900 provides a high-level overview. By clicking on links such as the Last BA and the OSUSER, the database administrator may view reports with more detail about the transaction and the particular user.

Generation of Names Related to Organization Actions

A system (e.g., system 100) for generating names related to organization actions allows administrative users, such as database administrators and other information technology (IT) professionals, to monitor performance in applications and servers. The system provides abstractions (e.g., organization actions) of activities performed by users with the applications. The system determines the abstractions from data (e.g., protocols and communication messages) sent between the applications and the servers.

The system then generates names related to the abstractions (e.g., the organization actions) that facilitate the administrator users in the identification and monitoring of the organization actions. The names may indicate the tasks and functions of organization actions performed with the applications. Additionally, the names may indicate one or more objects accessed and/or manipulated in the applications and the servers. The administrator users can then more efficiently troubleshoot and tune performance of user activities that are important and critical to an organization, such as a business or government entity.

The system for generating names related to organization actions performed with applications includes a communications interface and a processor. In general, the communications interface receives data sent between an application and a server in response to a user interacting with the application. The processor processes the data to determine an organization action performed with the application. A business action is one example of an organization action. An organization action is any step, function, or procedure for an organization that an application performs in response to a user interaction with the application. The processor generates a name related to the organization action performed with the application (e.g., a name for a technical transaction, an organization action, and/or an organization scenario) based on the data.

A name is any set of numbers, characters, and/or symbols that identifies, designates, and/or provides a reference to an abstraction of an activity performed by a user with an application. For example, the name may identify or refer to a technical transaction, an organization action, an organization scenario, and a description of the interaction of the user with the application. Some examples of names are numbers in a sequence (1, 2, 3 . . . ), letters in a sequence (A, B, C . . . ), combinations of numbers and characters, and international and/or Greek symbols. The name may be a unique or semi-unique identifier or reference, referring to a general organization action or a specific instance of the organization action.

In some embodiments, the system generates the name based on the data from highest ranked or “primary” SQL statements in the data. The system may also generate the name based on highest ranked technical transactions, the number of rows affected or fetched by an operation, the type (e.g., DDL or DML) of SQL commands, and aliases on “SELECT” statements. The database administrator may define an alias where a reference to an object does not represent the contents of the object. In some embodiments, the system generates the name based on an index in a sequence, a hash of a formula made from the components of the data (e.g., components in SQL statements), and/or a random identifier.

The system may generate the name related to the organization action based on at least one operation reference in the data. An operation reference is any keyword, identifier, and/or instruction in the data that directly or indirectly instructs a computer program (e.g., the application and the server) to perform a function, task, or operation. Some examples of operation references are SQL statement keywords, such as “SELECT” or “INSERT,” that instruct a database server (i.e., the database engine application) to perform operations on or to tables in the database server.

The system may also generate the name related to the organization action based on at least one object reference in the data. An object reference is any keyword or identifier in the data that directly or indirectly identifies or refers to an object. Some examples of objects are tables located in a database and files stored in a file server. The objects may be located, stored, and/or accessed in or by the application and/or the server. Some examples of object references in the data are table identifiers in SQL statements for tables located in the database and filenames for files stored in the file server.

Advantageously, the system generates names based on operation references and/or object references in the data that indicate the functions, tasks, or activities performed in applications and/or servers by users. By generating names directed to the operations or tasks, the system allows the administrator user to readily gather from the name a general and/or specific notion of the functions or tasks performed or enabled by the technical transactions, organization actions, and organization scenarios. The administrator user can monitor application and server performance and quickly determine from the names the technical transactions, organization actions, and organization scenarios performed by users.

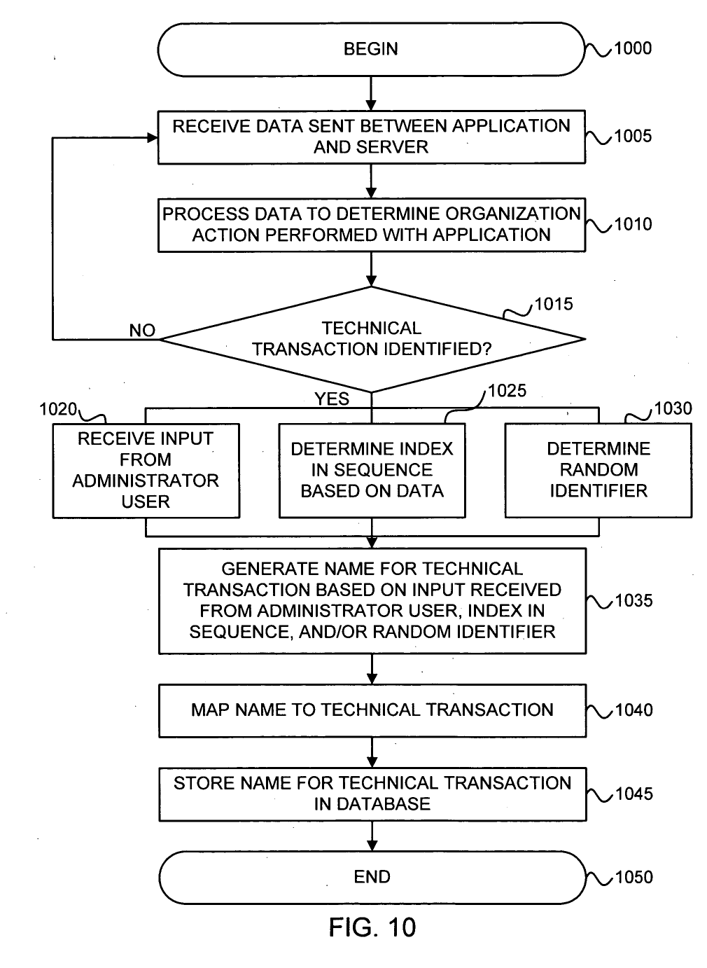

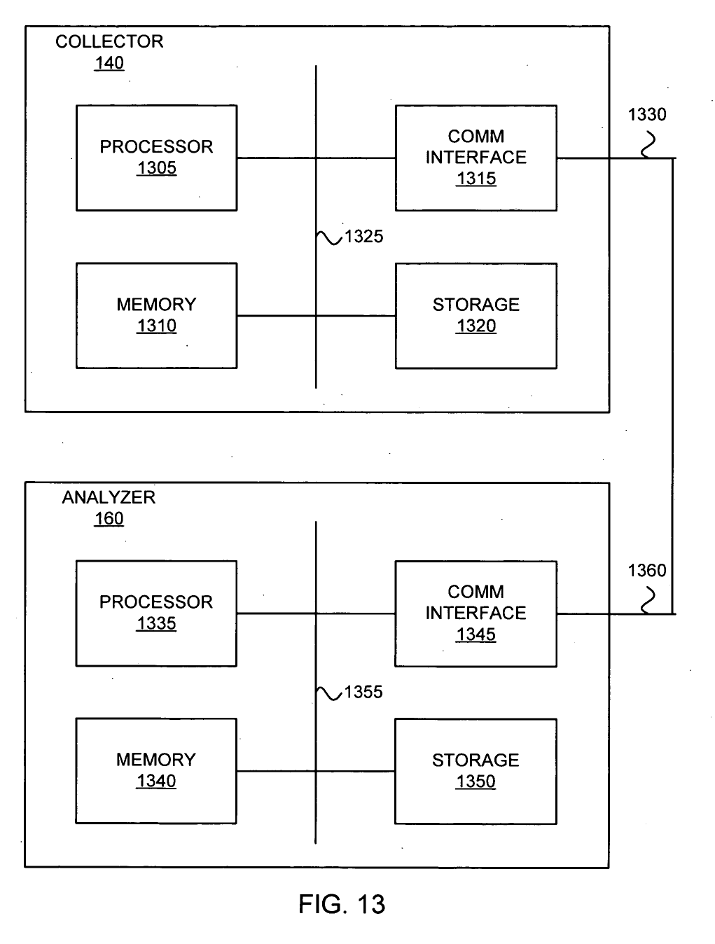

One embodiment of the system for generating names related to organization actions performed with applications is described further with respect to system 100 (see FIG. 1). Alternatively, to provide flexibility for integrating the system into existing hardware and software deployments, in some embodiments, the processor is included in the analyzer 160 and the communications interface is included in the collector 140 (e.g., proxy and sniffer configurations—see FIG. 1 and FIG. 13). Another embodiment of the system for generating names related to organization actions performed with applications is described further with respect to the analyzer 160 in FIGS. 10-13.

FIG. 10 is a flowchart for generating a name for a technical transaction, in an exemplary implementation of the invention. FIG. 10 begins in step 1000. In step 1005, the analyzer 160 receives data sent between an application (e.g., the application server 130) and a server (e.g., the database server 150). In step 1010, the analyzer 160 processes the data to determine an organization action performed with the application server 130. In this example, the organization action includes one or more technical transactions (see FIGS. 2-4), although not every organization action includes a technical transaction. In step 1015, the analyzer 160 determines whether a technical transaction has been identified. If a technical transaction is not identified, the analyzer 160 continues to receive data in step 1005.

In step 1015, if the analyzer 160 determines a technical transaction, the analyzer 160 may receive input from the administrator user to provide a name for the technical transaction in step 1020. Additionally in step 1025, the analyzer 160 may determine an index in a sequence based on the data to provide a name for the technical transaction. For example, the analyzer 160 may determine that the technical transaction is the second of three technical transactions forming the organization action. Based on the index (e.g., two) in the sequence of three, the analyzer 160 determines the index “2 of 3.” In step 1030, the analyzer 160 may determine a random identifier for the technical transaction.

In step 1035, the analyzer 160 generates the name for the technical transaction based on the input received from the administrator user, the index in the sequence, and/or the random identifier. For example, if the administrator user provides the input of “User Login,” the analyzer 160 may append the application name to the input and generate the name “BEA Medical Records—User Login” for the technical transaction. In another example, based on the index “2 of 3,” the analyzer 160 generates the name “2nd technical transaction of 3.”

In step 1040, the analyzer 160 maps the name to the technical transaction. For example, the analyzer 160 may create a dictionary of names. The dictionary defines a relation that maps names generated by the analyzer 160 to values. The values are pointers to or indexes for technical transactions, organization actions, and organization scenarios identified by the analyzer 160. In step 1045, the analyzer 160 stores the name in a database (e.g., the database server 170). The administrator user then can later search and retrieve the names from the database server 170. FIG. 10 ends in step 1050.

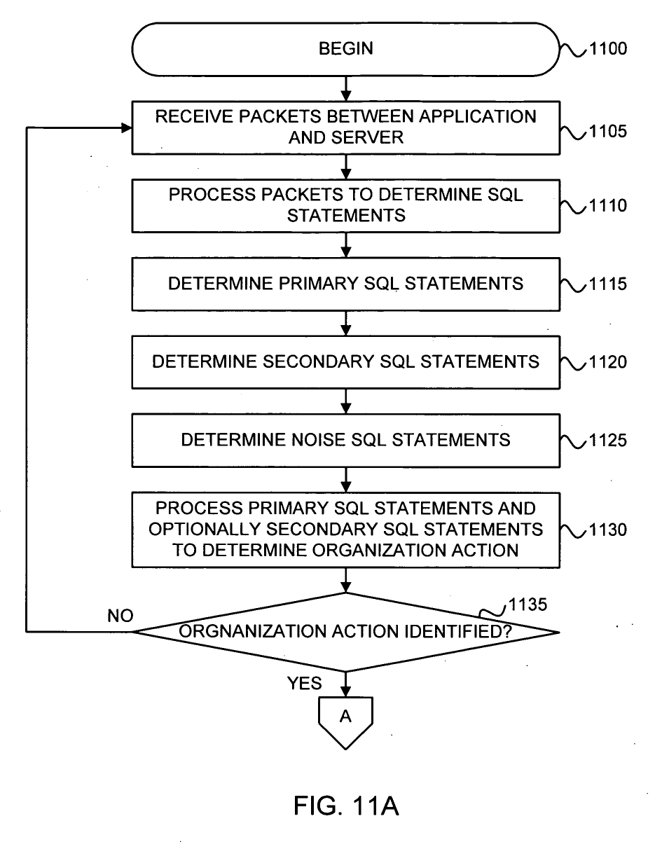

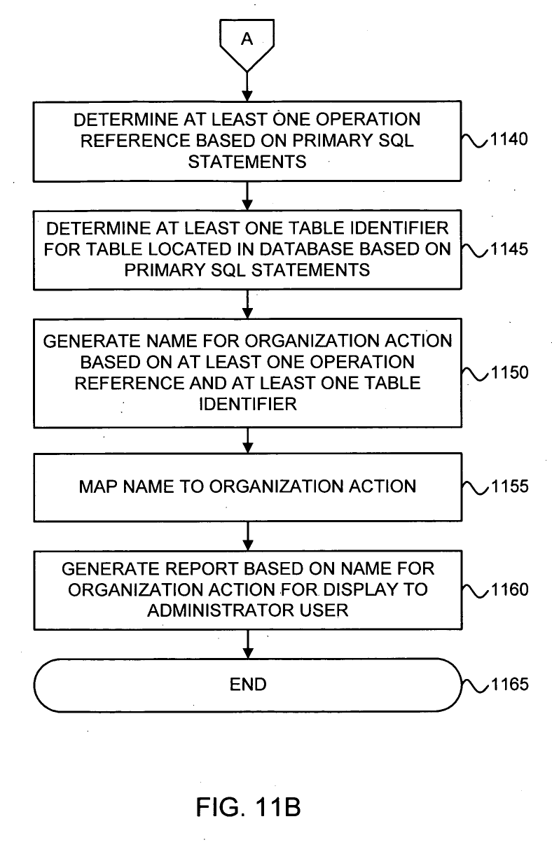

FIGS. 11A and 11B are a flowchart for generating a name for an organization action based on SQL statements, in an exemplary implementation of the invention. FIG. 11A begins in step 1100. In step 1105, the analyzer 160 receives packets sent between the application server 130 and the database server 150. In step 1110, the analyzer 160 processes the packets to determine SQL statements.

In step 1115, the analyzer 160 determines primary SQL statements from the SQL statements. Primary SQL statements are any SQL statements that represent or correspond to the main or primary action, task, or function performed or enabled by the SQL statements in an application or a server. Some examples of primary SQL statements are DML commands (Insert, Update & Delete), “SELECT” commands that select more than 5 columns, and “SELECT” commands that include a complex “WHERE” clause.

In step 1120, the analyzer 160 determines secondary SQL statements from the SQL statements. Secondary SQL statements are any SQL statements that serve the main or primary action performed or enabled by the primary SQL statements. Some examples of secondary SQL statements are “SELECT” commands that select less than 5 columns, “SELECT” commands that select from codes tables, and “INSERT” commands into a log table.

In step 1125, the analyzer 160 determines noise SQL statements from the SQL statements. Noise SQL statements are any SQL statements that may serve a technical purpose but not the main or primary action performed or enabled by the SQL statements in the application or the server. Some examples of noise SQL statements are “SELECT” commands to refresh an application caching mechanism, commands to insure a live database connection (Keep Alive), and commands to periodically check the existence of a row in a table serving as a persistent queue.

In step 1130, the analyzer 160 processes the primary SQL statements and optionally the secondary SQL statements to determine the organization action. In step 1135, if the analyzer 160 does not recognize an organization action, the analyzer 160 continues to receive data in step 1105. In step 1135, if the analyzer 160 identifies an organization action the flowchart continues at step 1140 in FIG. 11B.

Referring now to FIG. 11B, if the analyzer 160 identifies an organization action, the analyzer 160 determines at least one operation reference to be performed in the database server 150 based on the primary SQL statements in step 1140. The operation reference can refer to or indicate any operation, task, function, procedure, or routine performed by a server (e.g., the database server 150). Some examples of operations in the database server 150 are query data, update data, and insert data. In step 1145, the analyzer 160 determines at least one object reference to an object in the server based on the primary SQL statements. In this example, the analyzer 160 determines at least one table identifier for a table in the database server 150 based on the primary SQL statements.

Optionally, in some embodiments, the analyzer 160 determines operation references from the secondary SQL statements. Additionally, the analyzer 160 may determine object references from the secondary SQL statements. The analyzer 160 then may provide further unique or explanatory names for organization actions and organization scenarios.

In step 1150, the analyzer 160 generates a name for the organization action based on the at least one operation reference to be performed in database server 150 and the at least one table identifier. In one example, based on the following primary SQL statements:
SELECT*FROM record WL0 WHERE (WL0.id=:1);
SELECT*FROM vital_signs WL0 WHERE (WL0.id=:1); and
SELECT*FROM prescription WL0 WHERE (WL0.record_id=:1).
   The analyzer 160 determines the at least one operation reference to be a “SELECT” or a query reference. The analyzer 160 also determines three table identifiers “record,” vital_signs,” and “prescription.” The analyzer 160 may generate the name “Query Records, Vital Signs, Prescriptions.”

In another example, based on the following SQL statements:
SELECT WL0.id, WL0.city, WL0.country, WL0.state, WL0.street1, WL0.street2, WL0.zip FROM address WL0 WHERE (WL0.id=:1);
UPDATE patient SET dob=:1 WHERE id=:2; and
UPDATE address SET state=:1 WHERE id=:2.
   The analyzer 160 determines that the two “UPDATE” commands are primary SQL statements and the “SELECT” command is a secondary SQL statement. The analyzer 160 determines “patient” and “address” as object references (e.g., table identifiers to objects in the database server 150). The analyzer 160 may generate the name “Update Patient Address” based on the primary and the second SQL statements.

In step 1155, the analyzer 160 maps the name to the organization action. In step 1160, the analyzer 160 generates a report based on the name for the organization action for display to the administrator user. FIG. 11B ends in step 1165.

The analyzer 160 provides names for organization actions that are easily and quickly identifiable. The analyzer 160 generates the name of the organization action to indicate the primary or main action or operation performed with the application or between the application and the server. The analyzer 160 can automatically generate the names from the primary and optionally the secondary SQL statements in the data with or without input from the administrator user. For example, a user can call to a help desk to report a problem experience with an application. The administrator user can hear the user's account of the problem with the application and the activities the user attempted to perform. The administrator user can quickly search reports generated by the analyzer 160 for names of technical transactions, organization actions, and/or organization scenarios performed by the user that sound like or indicate the activities that the user attempted to perform when experiencing the problem.

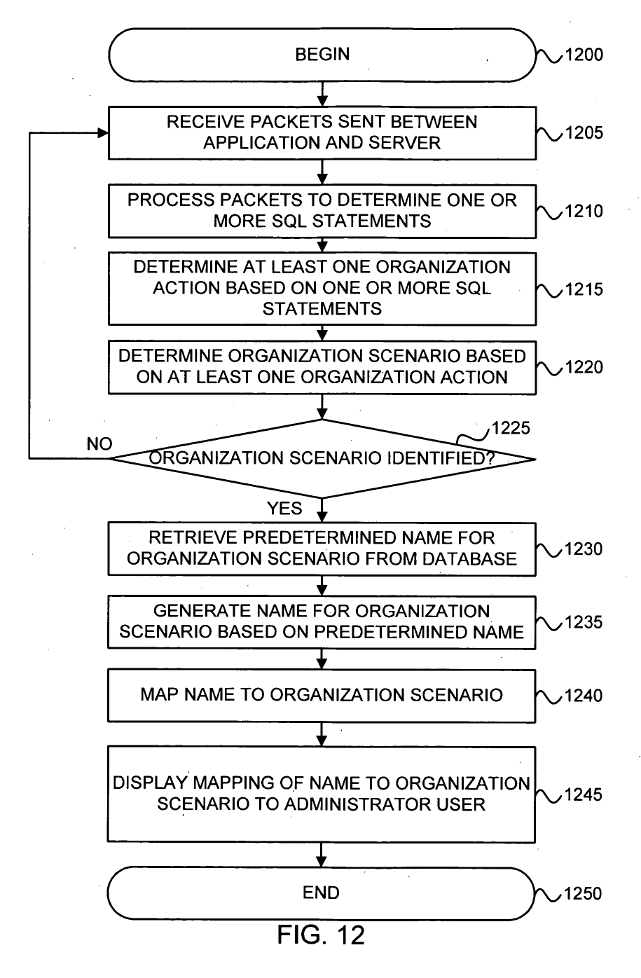

FIG. 12 is a flowchart for generating a name for an organization scenario from a predetermining name stored in a database, in an exemplary implementation of the invention. FIG. 12 begins in step 1200. In step 1205, the analyzer 160 receives packets sent between the application server 130 and the database server 150. In step 1210, the analyzer 160 processes the packets to determine one or more SQL statements. In step 1215, the analyzer 160 determines at least one organization action based on the one or more SQL statements.

In step 1220, the analyzer 160 determines an organization scenario based on the at least one organization action. In step 1225, if the organization scenario is not identified, the analyzer 160 continues to receive data in step 1205. If the organization scenario is identified, the analyzer 160 retrieves a predetermined name for the organization scenario from a database (e.g., the database server 170) in step 1230.

For example, the administrator user trains the analyzer 160 to recognize patterns or instances of technical transactions, organization action, and organization scenarios. During the training of the analyzer 160, the administrator user may designate names to or allow the analyzer 160 to map names to the patterns or instances of the technical transactions, organization action, and organization scenarios. The analyzer 160 may generate the mapping by correlating the primary SQL statements to the designated or automatically generated names. The administrator user stores the names along with the mappings in the database. In another example, the administrator user may purchase or download a list of predetermined names for technical transactions, organization action, and organization scenarios pre-mapped or correlated specifically for a particular software application.

The analyzer 160 then later retrieves the predetermined names from the database. For example, the analyzer 160 accesses the database to determine which name corresponds to or is mapped to a set of primary SQL statements in an organization action or organization scenario. If a match is determined, the analyzer 160 retrieves the name from the database.

In step 1235, the analyzer 160 generates the name for the organization scenario based on the predetermined name. The analyzer 160 may append the date and time of execution to the predetermined name. Alternatively, the analyzer 160 may append a random unique identifier to the predetermine name. In step 1240, the analyzer 160 maps the name to the organization scenario. In step 1245, the analyzer 160 generates a report based on the name for the organization scenario for display to the administrator user. The analyzer 160 may also display the name directly to the database administrator computer 190 (see FIG. 1). FIG. 12 ends in step 1250.

Advantageously, the analyzer 160 allows the administrator user to more easily monitor performance in the application and the server. The analyzer 160 generates familiar and quickly identifiable names for technical transactions, organization actions, and organization scenarios with or without input from the administrator user. By generating names based on the data, the analyzer 160 provides the administrator user the ability to easily monitor and identify patterns or instances of technical transactions, organization actions, and organization scenarios. The administrator user can then quickly identify by name user activities that fail or affect application and server performance.

FIG. 13 is a block diagram of the collector 140 and the analyzer 160, in an exemplary implementation of the invention. The collector 140 includes a processor 1305, memory 1310, a communications interface 1315, and storage 1320, which are all coupled to the bus 1325. Bus 1325 provides communications between the processor 1305, the memory 1310, the communications interface 1315, and the storage 1320. The analyzer 160 includes a processor 1335, memory 1340, a communications interface 1345, and storage 1350, which are all coupled to bus 1355. Bus 1355 provides communications between the processor 1335, the memory 1340, the communications interface 1345, and the storage 1350.

The processor 1305 and the processor 1335 execute instructions. The memory 1310 and the memory 1340 permanently or temporarily store data. Some examples of the memory 1310 and the memory 1340 are RAM and ROM. The storage 1320 and the storage 1350 also permanently or temporarily store data. Some example of the storage 1320 and the storage 1350 are hard disks and disk drives.

The communications interface 1315 communicates over a communication network (not shown) with the analyzer 160, the application server 130, and the database server 150 via line 1330 (see FIG. 1). The communications interface 1345 communicates over a communication network (not shown) with the collector 140, the database administrator computer 180, and the database server 170 via line 1360 (see FIG. 1).

FIG. 13 depicts one example of how the collector 140 and the analyzer 160 can be configured. There are numerous variations in which the collector 140 and the analyzer 160 can be configured. In one example, the collector 140 and the analyzer 160 can be combined into one device with a processor and a communication interface. In another example, the collector 140 is the communication interface and the analyzer 160 is the processor.

The above-described functions can be comprised of instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor(s), and storage media.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method for generating names related to organization actions performed with applications, the method comprising:
receiving data sent between an application and a server in response to a user interacting with the application;
processing the data to determine an organization action performed with the application; and
generating a name related to the organization action based on the data.

2. The method of claim 1 wherein the data comprises packets.

3. The method of claim 1 further comprising storing the name related to the organization action in a storage device.

4. The method of claim 1 wherein generating the name related to the organization action comprises generating the name based on at least one operation reference in the data.

5. The method of claim 1 wherein generating the name related to the organization action comprises generating the name based on at least one object reference in the data.

6. The method of claim 1 wherein generating the name related to the organization action comprises generating the name based on a predetermined name retrieved from a set of predetermined names.

7. The method of claim 1 wherein generating the name related to the organization action further comprises generating the name based on input received from an administrator user.

8. The method of claim 1 further comprising generating a report based on the name related to the organization action for display to an administrator user.

9. The method of claim 1 further comprising mapping the name to the organization action performed with the application.

10. A system for generating names related to organization actions performed in applications, the system comprising:
a communications interface configured to receive data sent between an application and a server in response to a user interacting with the application; and
a processor configured to process the data to determine an organization action performed with the application and generate a name related to the organization action based on the data.

11. The system of claim 10 wherein the communications interface is configured to receive the data as packets.

12. The system of claim 10 wherein the processor is configured to store the name related to the organization action in a storage device.

13. The system of claim 10 wherein the processor is configured to generate the name related to the organization action based on at least one operation reference in the data.

14. The system of claim 10 wherein the processor is configured to generate the name related to the organization action based on at least one object reference in the data.

15. The system of claim 10 wherein the processor is configured to generate the name related to the organization action based on a predetermined name retrieved from a set of predetermined names.

16. The system of claim 10 wherein the processor is further configured to generate the name related to the organization action based on input received from an administrator user.

17. The system of claim 10 wherein the processor is further configured to generate a report based on the name related to the organization action for display to an administrator user.

18. The system of claim 10 wherein the processor is further configured to map the name to the organization action performed with the application.

19. A software product for generating names related to organization actions performed in applications, the software product comprising:
software operational when executed by a processor to direct the processor to receive data sent between an application and a server in response to a user interacting with the application, process the data to determine an organization action performed with the application, and generate a name related to the organization action based on the data; and
a storage medium configured to store the software.

20. The software product of claim 19 wherein the data comprises packets.

21. The software product of claim 19 wherein the software is operational when executed by the processor to direct the processor to store the name related to the organization action in a storage device.

22. The software product of claim 19 wherein the software is operational when executed by the processor to direct the processor to generate the name related to the organization action based on at least one operation reference in the data.

23. The software product of claim 19 wherein the software is operational when executed by the processor to direct the processor to generate the name related to the organization action based on at least one object reference in the data.

24. The software product of claim 19 wherein the software is operational when executed by the processor to direct the processor to generate the name related to the organization action based on a predetermined name retrieved from a set of predetermined names.

25. The software product of claim 19 wherein the software is operational when executed by the processor to direct the processor to generate the name related to the organization action based on input received from an administrator user.

26. The software product of claim 19 wherein the software is operational when executed by the processor to further direct the processor to generate a report based on the name related to the organization action for display to an administrator user.

27. The software product of claim 19 wherein the software is operational when executed by the processor to further direct the processor to map the name to the organization action performed with the application.
